(19) United States
(12) Patent Application Publication
(10) Pub. No.: US 2026/0025040 A1
(43) Pub. Date: Jan. 22, 2026

(54) AXIAL FLUX MACHINE FOR A HIGH-VOLTAGE FAN

(71) Applicant: BorgWarner Inc., Auburn Hills, MI (US)

(72) Inventors: Daniel Härtel, Uhldingen-Mühlhofen (DE); Tobias Moser, Illmensee (DE)

(21) Appl. No.: 19/272,481

(22) Filed: Jul. 17, 2025

(30) Foreign Application Priority Data
Jul. 18, 2024 (DE) 102024120301.3

(51) Int. Cl. H02K 7/08; H02K 1/2796; H02K 7/14; H02K 15/144

(52) U.S. Cl. CPC H02K 7/083; H02K 1/2796; H02K 7/14; H02K 15/144; H02K 2201/03; H02K 2213/03

(57) ABSTRACT

The present invention relates to an axial flux machine (1) for a high voltage fan (100). The axial flux machine (1) comprises a housing (10), two stators (20), a rotor arrangement (30) and a bearing arrangement (40). The rotor arrangement (30) comprises a shaft (34) and a rotor disk (32) arranged on it. The bearing arrangement (40) mounts the rotor arrangement (30) rotatably in the housing (10). The rotor arrangement (30) is mounted on a first axial side (30a) via a locating bearing (42) of the bearing arrangement (40) against an axial bearing surface (12a) of the housing (10). Furthermore, the axial flux machine comprises a spacer element (50) which is designed and arranged between the rotor disk (32) and the axial bearing surface (12a) so as to set axial gaps (122a, 122b) between the rotor disk (32) and the stators (20).

### CROSS-REFERENCE TO RELATED APPLICATIONS

This application claims priority pursuant to 35 U.S.C. 119(a) to German Patent Application No. 102024120301.3 filed Jul. 18, 2024, which application is incorporated herein by reference in its entirety.

### TECHNICAL FIELD

The present disclosure relates to an axial flux machine with two stators and a centrally running rotor disk, and to a corresponding method for setting the axial gaps between the rotor disk and the stators. In particular, the disclosure relates to a high voltage fan with an axial flux machine of this type.

### BACKGROUND

Electric machines have always been used in many technical fields for the generation of kinetic energy. An electric machine is an electric unit which can convert electric energy into mechanical energy (also called an electric motor or E-motor), or can conversely convert mechanical energy into electric energy (also called a generator). The mechanical energy can be used in turn to generate kinetic energy, by way of which other units can be driven. Here, the electric motor generally comprises a stator and a rotor which are accommodated in a motor housing. In frequent applications, the stator is fixed in its position, and the rotor moves relative to the stator and is usually seated on a drive shaft which rotates together with the rotor. The rotational energy can be transmitted via the shaft to other units. Most electric motors generate energy with a magnetic field and a winding current.

A distinction can fundamentally be made between radial flux machines and axial flux machines. In the case of radial flux machines, the rotor and the stator are spaced apart from one another radially (by a radial gap), wherein the generated magnetic flux is a radial flux in the case of a radial flux machine.

In the case of axial flux machines, the rotor as a rule comprises a disk-shaped rotor body (also called a rotor disk or disk rotor) with two circular surfaces which are connected by a thickness, wherein the disk is delimited by an outer collar and an inner circumference which delimits a space for a rotating shaft. The rotor disk supports a plurality of permanent magnets. The stator is as a rule of disk-shaped configuration and is arranged fixedly in a manner spaced apart axially (via an axial gap) from the rotor. On its side which faces the rotor, the stator supports a plurality of circumferentially distributed winding elements. Each winding element comprises in each case one stator tooth which, starting from a stator yoke, extends in the axial direction toward the rotor. The stator tooth is wound around by a wire comprising a metallic, satisfactorily conducting material, in order to form the winding. When the windings are supplied with current, the rotor which is fastened to the output shaft of the motor is subjected to a torque which results from the magnetic field, wherein the generated magnetic flux is an axial flux in the case of an axial flux machine. In the case of axial flux machines, the rotor and the stator are spaced apart in the axial direction by an axial gap (also called an axial clearance) and are therefore also frequently called axial gap machines. The permanent magnets are usually attached to one (one stator) or the two (two stators) circular surfaces of the rotor body, which surface is called a supporting surface. The rotor of an axial flux machine can be driven by one stator on one side of the rotor or by two stators on both sides of the rotor. In the case of a rotor with a single air gap which is intended to be operated by way of a single stator, a single circular surface of the rotor body frequently supports the magnets. In the case of a rotor with two air gaps which is intended to be operated with two stators, the two circular surfaces frequently support the magnets. The magnets are each held on the circular surface by holding means, wherein a spacing is left between the at least two magnets on the same surface. In particular, in the case of axial flux machines with two stators, the permanent magnets can also be secured in pockets or windows of the rotor disk. The pockets or windows can be configured as axial depressions or axial passages through the rotor disk.

Electric motors, in particular in high voltage applications of up to 800 V and more, as a rule generate heat during the operation. During the operation of an axial flux motor, however, the magnetic forces can push the permanent magnets in the axial direction in addition to the provision of the torque, even at a standstill. As a result, there is the risk that the rotor tends to bend axially toward one of the stators, which can lead in the worst case to the rotor making contact with the respective stator. In particular in the case of very small axial gaps and in the high voltage range, the axial forces can lead to negative effects for the entire axial flux machine. On the other hand, very small axial gaps are advantageous for the efficiency of the axial flux machine and additionally lead to a lower installation space requirement.

It is an object of the present invention to provide a more reliable axial flux machine with two stators in an inexpensive manner.

### SUMMARY

The present invention relates to an axial flux machine as claimed in claim 1. Furthermore, the invention relates to a high voltage fan with an axial flux machine of this type as claimed in claim 7. In addition, the invention relates to a method for setting axial gaps as claimed in claim 8.

The axial flux machine according to the invention comprises a housing, two stators, a rotor arrangement and a bearing arrangement. The rotor arrangement comprises a shaft and a rotor disk arranged on it. The bearing arrangement is configured to mount the rotor arrangement rotatably in the housing. The rotor arrangement is mounted on a first axial side via a locating bearing of the bearing arrangement against an axial bearing surface of the housing. Furthermore, the axial flux machine comprises a spacer element which is designed and arranged between the rotor disk and the axial bearing surface so as to set axial gaps between the rotor disk and the stators. The axially central centering of the rotor disk between the two stators can be improved by the provision of the spacer element. In particular, deviations from axially central running on account of the tolerance chain of the parts between the axial bearing surface (in the case of the locating bearing) and the rotor disk can be compensated for. Therefore, despite manufacturing tolerances of the parts which as a rule occur in the production method, a very small axial gap (on both sides of the rotor disk) and at the same time very homogeneous axial gaps can be implemented. As a result of a small difference between the axial gaps, the (resulting) axial forces which act on the rotor disk can be reduced. In other words, the axial forces which act on the rotor disk can be substantially equalized. In addition, the production can be simplified, since the individual tolerances of the parts do not have to be so precise (or small) as a result of the provision of the spacer element, as would be the case without the spacer element.

In refinements of the axial flux machine, the spacer element can be arranged at a first axial position between the axial bearing surface and the locating bearing. In particular, the spacer element can bear at the first axial position against the axial bearing surface and against an opposite outer bearing shoulder of the locating bearing. In refinements, the spacer element can be arranged at a second axial position between the locating bearing and a first shaft shoulder of the shaft. In particular, the spacer element can bear at the second axial position against the first shaft shoulder and against an opposite inner bearing shoulder of the locating bearing. In refinements, the spacer element can be arranged at a third axial position between a second shaft shoulder of the shaft and the rotor disk. In particular, the spacer element can bear at the third axial position against the second shaft shoulder and against the rotor disk. The present invention provides by way of example three different positioning possibilities within the tolerance chain of the parts of the rotor arrangement between the axial bearing surface (in the case of the locating bearing) and the rotor disk. Therefore, positioning of the spacer element can be adapted to different refinements of the axial flux machine and/or to the production processes. For example, in particular, the first and the second axial position are practicable in the case of rotor arrangements, in which the rotor disk protrudes at least partially radially out of the shaft (for example, is produced at least partially in one piece with the shaft).

In refinements of the axial flux machine, the spacer element can be of annular configuration. The spacer element can have an axial thickness between two axial surfaces which lie opposite one another. In particular, homogeneous setting of the axial gaps over their entire circumference can be achieved by the annular refinement.

In refinements of the axial flux machine, the axial thickness can be configured in such a way that a difference between the axial gaps is smaller than without the spacer element.

In refinements of the axial flux machine, the axial thickness can be configured in such a way that a difference of the axial gaps between the rotor disk and the stators is less than or equal to 0.5 mm. In particular, the axial thickness can be configured in such a way that the difference of the axial gaps between the rotor disk and the stators is less than or equal to 0.2 mm. In some preferred refinements, the axial thickness can be configured in such a way that a difference of the axial gaps between the rotor disk and the stators is less than or equal to 0.1 mm. An improvement of the axially middle centering can be achieved by refinements of this type. A pronounced reduction of the resulting axial forces which act on the rotor disk can be achieved, in particular, in comparison with greater differences between the axial gaps.

In refinements of the axial flux machine, the axial gaps can comprise a front axial gap and a rear axial gap. The front axial gap can also be called a first axial gap. The rear axial gap can also be called a second axial gap. The front axial gap can be arranged on the first axial side. The rear axial gap can be arranged on a second side which lies opposite the first side. In refinements, the front axial gap can be of smaller configuration than the rear axial gap. In other words, the axial thickness of the spacer element can be configured in such a way that the front axial gap is smaller than the rear axial gap. Thermally induced vibrations or alternating loading during operation can be avoided or the risk thereof can at least be reduced by the smaller configuration of the first axial gap. This risk can exist on account of thermal expansions to different extents at the first and at the second axial gap. On account of the arrangement of the locating bearing on the same (first) axial side as the first axial gap, the first axial gap tends to become smaller during heating of the axial flux machine in comparison with the second axial gap.

In refinements of the axial flux machine, the front axial gap can be set by the spacer element to 1.5 mm±0.5 mm. In particular, the front axial gap can be set by the spacer element to 1.5 mm±0.3 mm. In some preferred refinements, the front axial gap can be set by the spacer element to 1.5 mm±0.2 mm. In refinements, the rear axial gap can be set by the spacer element to 1.5 mm±0.5 mm. In particular, the rear axial gap can be set by the spacer element to 1.5 mm±0.3 mm. In some preferred refinements, the rear axial gap can be set by the spacer element to 1.5 mm±0.2 mm.

In refinements of the axial flux machine, the rotor disk can comprise a holding body and a plurality of permanent magnets distributed in the circumferential direction. The permanent magnets can be fastened to the holding body. In refinements, the plurality of permanent magnets can define a first axial rotor surface and an opposite second axial rotor surface of the rotor disk.

In refinements of the axial flux machine, the rotor disk can be connected fixedly to the shaft for conjoint rotation via a rotor disk fixing.

In refinements of the axial flux machine, furthermore, the bearing arrangement can comprise a bearing fixing. The bearing fixing can be designed and arranged to brace the locating bearing in the axial direction toward the axial bearing surface. In particular, the bearing fixing can brace the outer bearing ring of the locating bearing. The bearing fixing can be fastened in the housing, in particular as a screw connection (for example, by one or more clamping elements such as clamping jaws).

In refinements of the axial flux machine, the housing can comprise a first housing part and a second housing part. A first stator of the two stators can be fastened in the first housing part. A second stator of the two stators can be fastened in the second housing part. In particular, the rotor disk can be arranged axially between the first stator and the second stator.

Furthermore, the present invention relates to a high voltage fan. The high voltage fan comprises an axial flux machine in accordance with any one of the preceding refinements. In addition, the high voltage fan comprises a fan impeller. The fan impeller is coupled fixedly to the shaft for conjoint rotation outside the housing.

Furthermore, the present invention relates to a method for setting axial gaps between the rotor disk and the stators of an axial flux machine. The axial flux machine comprises a housing with an axial bearing surface on a first axial side, and a rotor arrangement with a shaft and the rotor disk arranged on it. The rotor arrangement is mounted on the first axial side via a locating bearing of a bearing arrangement of the axial flux machine against the axial bearing surface. The method comprises the following steps: determining the axial gaps between the stators and the rotor disk. Determining the difference between the axial gaps. Defining, based on the determined difference, an axial thickness of a spacer element, with the result that the difference is reduced. Arranging the spacer element in an axial dimensional chain between the rotor disk and the axial bearing surface.

In refinements of the method, determining the axial gaps can comprise determining axial rotor distances between an outer bearing shoulder on the first axial side of the locating bearing and a respective axial surface of the rotor disk.

In refinements of the method, determining the respective axial rotor distance can comprise a plurality of, in particular at least three, measurements at positions distributed in the circumferential direction of the respective axial rotor surface, and averaging the respective plurality of measurements.

In refinements of the method, determining the axial gaps can comprise determining axial stator differences between the axial bearing surface and a respective axial stator surface on the stators.

In refinements of the method, determining the respective axial stator distance can comprise a plurality of, in particular at least three, measurements at positions distributed in the circumferential direction of the respective axial stator surface, and averaging the respective plurality of measurements.

In refinements of the method, determining the axial gaps can comprise defining differences between the respective axial stator distance and the respective axial rotor distance.

In refinements of the method, determining the axial gaps can comprise determining a first axial gap between a first stator and a first axial rotor surface of the rotor disk. In addition, determining the axial gaps can comprise determining a second axial gap between a second stator and a second axial rotor surface of the rotor disk.

Determining the first axial gap can comprise determining a first axial rotor distance between an outer bearing shoulder on the first axial side of the locating bearing and a first axial surface of the rotor disk. In refinements, determining the first axial gap can comprise determining a first axial stator distance between the axial bearing surface and a first axial stator surface on the first stator. In refinements, determining the first axial gap can comprise defining a difference between the first axial stator distance and the first axial rotor distance. In refinements, determining the first axial rotor distance can comprise a plurality of, in particular at least three, measurements at positions distributed in the circumferential direction of the first axial rotor surface, and averaging the plurality of measurements. In particular, the positions can be distributed in the circumferential direction and/or in the radial direction. In refinements, determining the first axial stator distance can comprise a plurality of, in particular at least three, measurements at positions distributed in the circumferential direction of the first axial stator surface, and averaging the plurality of measurements. In particular, the positions can be distributed in the circumferential direction and/or in the radial direction.

Determining the second axial gap can comprise determining a second axial rotor distance between the outer bearing shoulder and the second axial surface of the rotor disk. In refinements, determining the second axial gap can comprise determining a second axial stator distance between the axial bearing surface and a second axial stator surface on the second stator. In refinements, determining the second axial gap can comprise defining a difference between the second axial stator distance and the second axial rotor distance. In refinements, determining the second axial rotor distance can comprise a plurality of, in particular at least three, measurements at positions distributed in the circumferential direction of the second axial rotor surface, and averaging the plurality of measurements. In particular, the positions can be distributed in the circumferential direction and/or in the radial direction. In refinements, determining the second axial stator distance can comprise a plurality of, in particular at least three, measurements at positions distributed in the circumferential direction of the second axial stator surface, and averaging the plurality of measurements. In particular, the positions can be distributed in the circumferential direction and/or in the radial direction.

In refinements of the method, the axial thickness of the spacer element can be defined in such a way that a first axial gap of the two axial gaps which is formed on the first axial side is smaller than a second axial gap. Thermally induced vibrations and/or alternating loading can be avoided or the risk thereof can at least be reduced during operation by the smaller configuration of the first axial gap. This risk can exist on account of thermal expansions of different magnitude at the first and at the second axial gap. On account of the arrangement of the locating bearing on the same (first) axial side as the first axial gap, the first axial gap tends to become smaller during heating of the axial flux machine in comparison with the second axial gap.

In refinements of the method, the axial thickness of the spacer element can be defined in such a way that the difference between the axial gaps is less than or equal 0.5 mm, in particular less than or equal to 0.2 mm, preferably less than or equal to 0.1 mm. An improvement of the axially middle centering can be achieved by refinements of this type. A pronounced reduction of the resulting axial forces which act on the rotor disk can be achieved, in particular, in comparison with greater differences between the axial gaps.

In refinements of the method, the axial thickness of the spacer element can be defined in such a way that a first axial gap and/or a second axial gap are/is set by the spacer element to 1.5 mm±0.5 mm, in particular 1.5 mm±0.3 mm, preferably 1.5 mm±0.2 mm.

In refinements of the method, the axial flux machine can be provided with nominal dimensions of this type which influence the axial gaps by a spacer element with an axial nominal thickness of at least 0.5 mm being necessary to reduce the nominal difference between the axial gaps. In refinements, the axial thickness of the spacer element can be defined by the axial thickness being increased or reduced starting from the axial nominal thickness. In refinements, the increase or reduction can take place based on the determined difference between the axial gaps.

In refinements of the method, arranging the spacer element can comprise one of the following arrangements. Arranging the spacer element at a first axial position between the axial bearing surface and the locating bearing. As an alternative, arranging the spacer element at a second axial position between the locating bearing and a first shaft shoulder. As an alternative, arranging the spacer element at a third axial position between a second shaft shoulder and the rotor disk.

### BRIEF DESCRIPTION OF THE DRAWINGS

Further features are evident from the appended drawings which form part of this disclosure. The drawings are intended to serve to further explain the present disclosure and to make it possible for a person skilled in the art to put the present disclosure into practice. The drawings are to be understood, however, as non-restricting examples. Common designations in different Figures indicate identical or similar features.

FIG. 1 shows a perspective illustration of the high voltage fan according to the invention with an axial flux machine;

FIG. 2 shows a diagrammatic sectional illustration of the axial flux machine along the section A-A from FIG. 1 in one exemplary embodiment with two stators;

FIGS. 3a and 3b show a front view and a sectional view of the annular spacer element;

FIG. 4 shows a diagrammatically simplified sectional illustration of the axial flux machine of the detail B from FIG. 2 with three exemplary positions of the spacer element;

FIG. 5 diagrammatically shows a flow chart of a method for setting the axial gaps of the axial flux machine;

FIGS. 6a and 6b show a diagrammatically simplified comparison of the detail B from FIG. 2 with and without a spacer element; and

FIG. 7 diagrammatically shows the rotor arrangement with a locating bearing, the first housing part with the first stator, and the second housing part with the second stator before assembly, and the diagrammatic measurement of the rotor distances and the stator distances.

### DETAILED DESCRIPTION

Embodiments of the axial flux machine, the high voltage fan and the method according to the present disclosure will be explained in the following text with reference to the drawings.

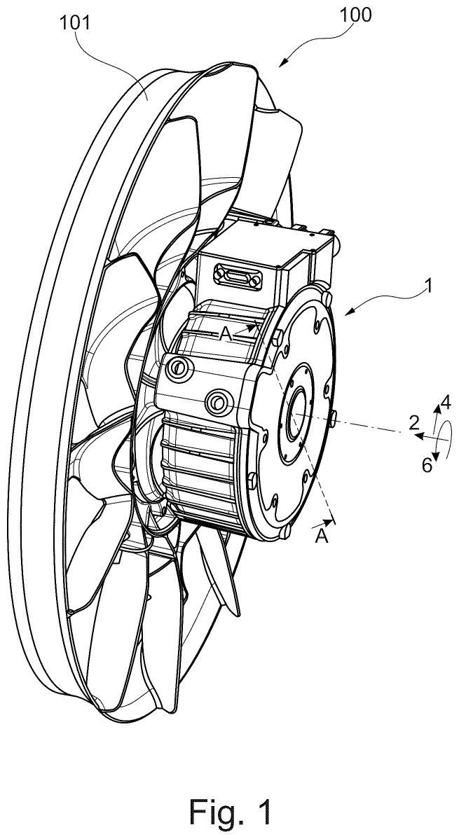

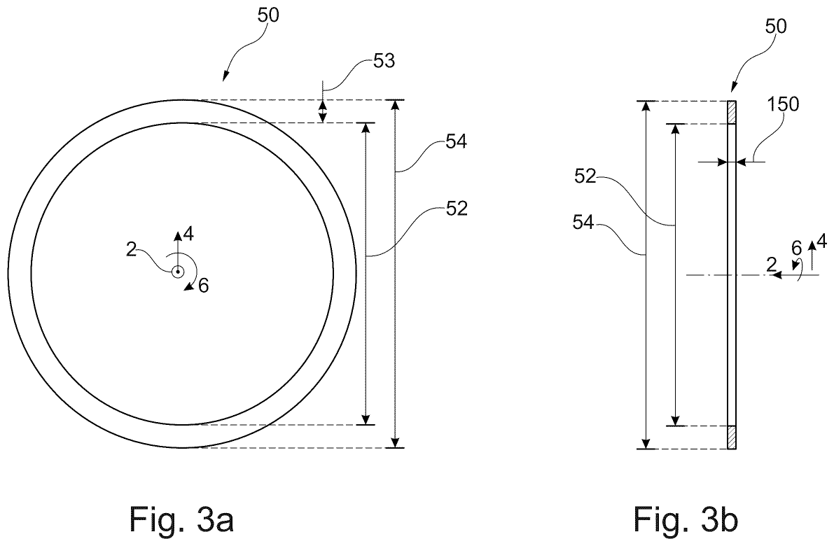

Within the context of this application, the terms axial or axial direction relate to a rotational axis of the rotor arrangement 30 (and/or the shaft 34 and/or the axial flux machine 1). The figures (see, for example, FIGS. 1, 2, 3a, 3b, 6a, 6b and 7) show the axial direction 2 of the rotor arrangement 3 using the designation 2. The term radial or radial direction is to be understood in relation to the axis/axial direction 2 of the rotor arrangement 30 and is shown using the designation 4. A circumference, circumferential, or circumferential direction likewise relates to the axis/axial direction 2 of the rotor arrangement 30 and is labeled with the designation 6. It is to be understood that, although only one exemplary direction is shown in each case in the respective figures, the respective counter-direction also falls within the respective term. Thus, for example, FIG. 3a shows the circumferential direction 6 using an arrow oriented in the clockwise direction. The direction counter to the clockwise direction about the axis 2 can also be denoted as circumferential direction 6, however. This also applies analogously to the axial direction 2 and the radial direction 4, wherein the latter can comprise every radial direction 4 starting from the axis/axial direction 2.

FIG. 1 shows an exemplary high voltage fan 100 in accordance with the present disclosure. The fan 100 comprises an axial flux machine 1 and a fan impeller 101. The fan impeller 101 can be driven by the axial flux machine 1. For this purpose, the fan impeller 101 is arranged fixedly on a shaft 34 of the axial flux machine 1 for conjoint rotation outside a housing 10 of the axial flux machine 1. In the perspective illustration of FIG. 1, merely the housing 10 and the fan impeller 101 can be seen by way of illustration. In addition, the high voltage fan 101 can comprise a cooling apparatus in embodiments. In this regard, FIG. 1 shows cooling connectors for feeding and discharging cooling fluid for cooling the axial flux machine 1. In addition, electrical connectors of the axial flux machine 1 are shown. The illustrated fan 100 or its components is/are configured as a high voltage fan 100. In particular, the axial flux machine 1 can be configured here as a high voltage axial flux machine 1. This means that the axial flux machine 1 is dimensioned for applications in the high voltage range at operating voltages of up to 800 V and more. The fan 100 can be used, in particular, to cool components of an electric vehicle (for example, a battery-operated electric vehicle, in particular a motor vehicle such as a passenger motor vehicle or a commercial vehicle). As an alternative, the fan 100 can also be used in further (in particular, mobile) applications, in which a high (cooling) performance is required. These also include, in particular, applications with an electric motor and/or an internal combustion engine. For example, the fan 100 can be used in applications with drive motors of similarly large dimensions such as an electric vehicle. Applications of this type can also comprise, for example, machines or vehicles with internal combustion engines and/or electric motors such as construction machines, generators or cranes, to mention only some examples.

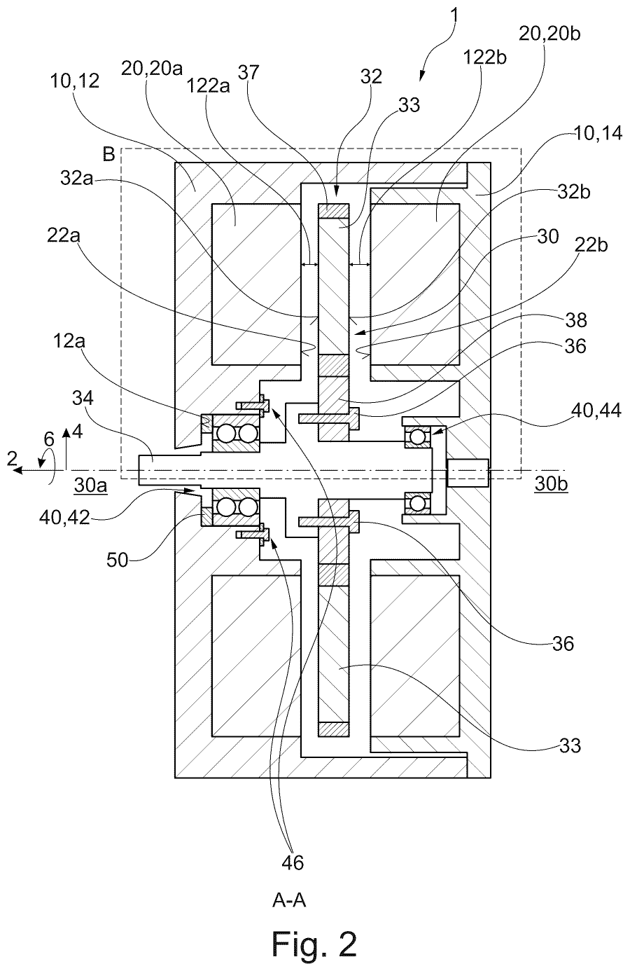

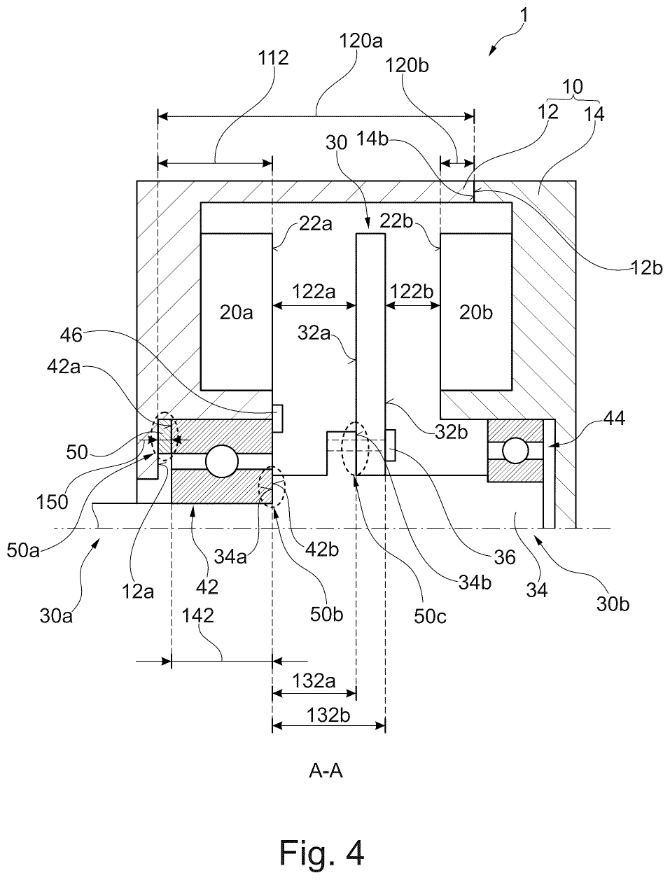

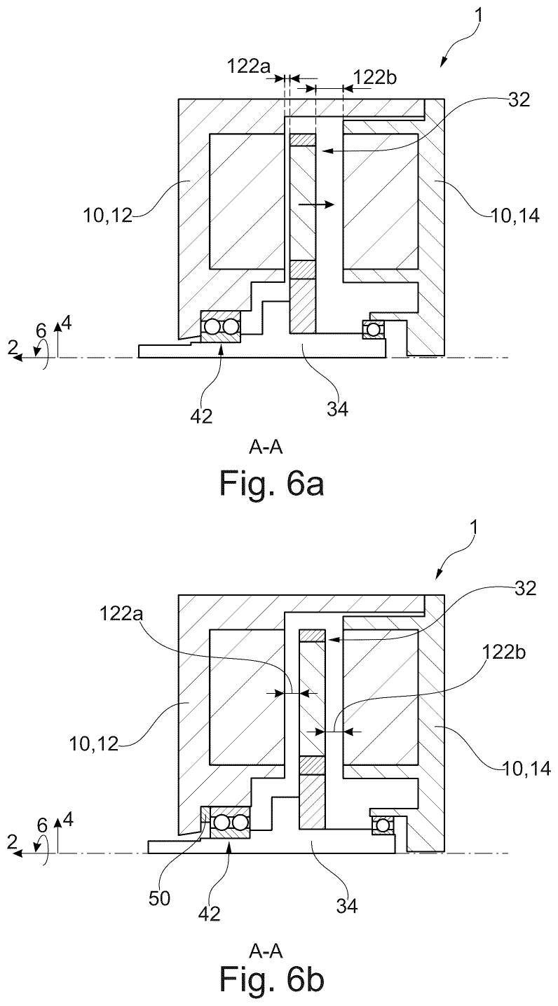

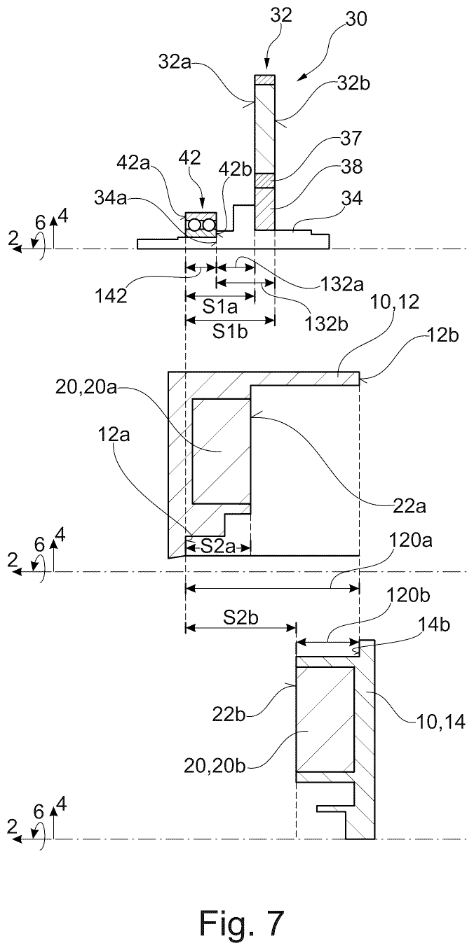

FIG. 2 shows the axial flux machine 1 in a diagrammatically simplified sectional illustration along the section A-A from FIG. 1. In the exemplary embodiment, the axial flux machine 1 comprises a housing 10, two stators 20, a rotor arrangement 30 and a bearing arrangement 40. The rotor arrangement 30 comprises a shaft 34 and a rotor disk 32 arranged on it. In particular, the rotor disk 32 is arranged fixedly on the shaft 34 for conjoint rotation and axially between the two stators 20. As shown in FIG. 2 (see also FIG. 4 and, analogously, FIGS. 6a, 6b and 7), a first axial side 30a and an opposite second axial side 30b can be defined with regard to the rotor arrangement 30. Within the context of the present disclosure, the first axial side 30a can also be described as a front side 30a, and the second axial side 30b can also be described as a rear side 30b. The axial sides 30a, 30b are to be understood in relation to an axially central region, on which the rotor disk 32 is arranged. The bearing arrangement 40 is configured to mount the rotor arrangement 30, in particular the shaft 34 thereof, rotatably in the housing 10.

In the exemplary embodiment of FIG. 2 (see also FIG. 4), the bearing arrangement 40 comprises a locating bearing 42 and a floating bearing 44 to this end. The locating bearing 42 is arranged on the first axial side 30a. The floating bearing 44 is arranged on the second axial side 30b. The rotor arrangement 30 is mounted on a first axial side 30a via the locating bearing 42 of the bearing arrangement 40 against an axial bearing surface 12a of the housing 10. More specifically, the locating bearing 42 can be mounted via an outer bearing shoulder 42a toward the first axial side 30a (see FIG. 4). The outer bearing shoulder 42a is a bearing shoulder of an outer bearing ring of the locating bearing 42. In particular, the outer bearing shoulder 42a defines an axial surface which points in the axial direction 2 (toward the first axial side 30a). Via an inner bearing shoulder 42b of an inner bearing ring of the locating bearing 42, the locating bearing can be mounted axially against the first shaft shoulder 34a of the shaft 34. The inner bearing shoulder 42b is a bearing shoulder of the inner bearing ring of the locating bearing 42. In particular, the inner bearing shoulder 42b defines an axial surface which points in the axial direction 2 (toward the second axial side 30b). The axial bearing surface 12a can be formed by the housing 10, in particular by a housing shoulder of the housing 10. In embodiments of the axial flux machine 1, the bearing arrangement 40 can comprise a bearing fixing 46, furthermore. The bearing fixing 46 can be designed and arranged to brace the locating bearing 42 in the axial direction 2 toward the axial bearing surface 12a. In particular, the bearing fixing 46 can brace the outer bearing ring of the locating bearing 42 (via a bearing shoulder (without designation) which lies opposite the outer bearing shoulder 42a). The bearing fixing 46 can be configured, in particular, as a screw connection (for example, by one or, as shown in FIG. 2, a plurality of clamping elements such as clamping jaws). As likewise shown in FIG. 2, the bearing fixing 46 can be fastened in the housing 10.

With reference to FIG. 2, furthermore, the two stators 20 comprise a first stator 20a and a second stator 20b. The rotor disk 32 is arranged axially between the first stator 20a and the second stator 20b. The first stator 20a is arranged relative to the rotor disk 32 on the first axial side 30a and can therefore also be called a front stator 20a. The second stator 20b is arranged relative to the rotor disk 32 on the second axial side 30b and can therefore also be called a rear stator 20b. As likewise shown in FIG. 2, the housing 10 can comprise a first housing part 12 (also called a front housing part 12) and a second housing part 14 (also called a rear housing part 14). The first stator 20a is fastened in the first housing part 12. The second stator 20b is fastened in the second housing part 14.

The rotor disk 32 comprises a plurality of permanent magnets 33 which are distributed in the circumferential direction 6 and of which two can be seen in the sectional view of FIG. 2. Therefore, the rotor disk 32 can rotate together with the shaft 34 in the housing 10, wherein the two stators 20 drive the rotor disk 32. For this purpose, each of the stators 20 can have an annular stator yoke with a plurality of stator teeth (not shown in detail) which, distributed in the circumferential direction 6, extend from the stator yoke in the axial direction 2 toward the rotor disk 32. The stators 20 or their stator teeth are wound around with electrical lines (not shown), in order to form windings. As has already been mentioned, FIGS. 2 and 4 are a diagrammatically simplified illustration of the axial flux machine 1, with the result that the details, for example the stators 20, cannot be seen in detail. When the windings are loaded with a drive current, a magnetic field can be generated which is suitable for acting on the rotor disk 32 or its permanent magnets 33 and driving it/them.

An air gap 122a, 122b is provided in each case in the axial direction 2, which is clearly visible in FIG. 2, between the rotor disk 32 and the stators 20. These air gaps 122a extend in the axial direction 2 and can therefore also be called an axial air gap or axial gap 122a, 122b. More precisely, a first axial gap 122a (also called a front axial gap 122a) is configured between the first stator 20a and the rotor disk 32. A second axial gap 122b (also called a rear axial gap 122b) is configured between the second stator 20b and the rotor disk 32. For improved visualization, the axial gaps 122a, 122b are shown in a greatly enlarged manner. The rotor disk 32, in particular its permanent magnets 33, defines/define a first axial rotor surface 32a and an opposite second axial rotor surface 32b. The first stator 20a defines a first axial stator surface 22a which points toward the rotor disk 32 or lies opposite the first axial rotor surface 32a. The second stator 20b defines a second axial stator surface 22b which points toward the rotor disk 32 or lies opposite the second axial rotor surface 32b. The front axial gap 122a extends from the first axial stator surface 22a to the first axial rotor surface 32a. The rear axial gap 122b extends from the second axial stator surface 22b to the second axial rotor surface 32b.

In the light of the present disclosure, an “axial surface” can be understood to be a surface, the normal vector of which points substantially in the axial direction 2. Here, “pointing substantially in the axial direction 2” can include deviations of up to 5°, in particular up to 3°. For example, the axial bearing surface 12a points in the axial direction 2 toward the second axial side 30b.

In the light of the present disclosure, the axial gaps (and their difference) relate to mean dimensions which are measured at room temperature and not during operation of the axial flux machine. Mean dimensions are to be understood to be mean values of values measured at at least three different positions in the circumferential direction, in particular at at least three positions distributed homogeneously in the circumferential direction. In refinements, mean values can be formed over at least three different positions in the circumferential direction on a plurality of reference circles with different radii (in particular, a (maximum) radially outer reference circle and a (maximum) radially inner reference circle and/or reference circles in between).

As has already been mentioned, the rotor disk 32 comprises a plurality of permanent magnets 33 fastened to it. To this end, the rotor disk 32 can comprise a holding body 37 which fixes the permanent magnets 33. The permanent magnets can be fastened to the holding body 37. For example, the holding body 37 can be configured as a plastic overmolding, by way of which the permanent magnets 33 are encapsulated and as a result fixed. The permanent magnets 33 can be at least partially free from plastic overmolding on the axial rotor surfaces 32a, 32b. It goes without saying that other fastening methods of the permanent magnets 33 are also possible. Nevertheless, the solution with a plastic overmolded holding body 37 affords the advantage that a non-metallic material (and therefore non-electrically conducting material or at least less electrically conducting material than a metallic material) is used in the magnetically active region between the stators 20. As a result, eddy current losses are reduced during operation.

In some refinements, the rotor disk 32 can be connected fixedly to the shaft 34 for conjoint rotation via a rotor disk fixing 36 (see FIGS. 2 and 4). As has already been mentioned, the shaft 34 comprises a first shaft shoulder 34a. The first shaft shoulder 34a defines an axial surface which is designed for contact of the locating bearing 42 (or of the spacer element 50 mentioned below in the case of positioning at the axial position 50b). In addition, the shaft 34 comprises a second shaft shoulder 34b. The first shaft shoulder 34a is spaced apart from the second shaft shoulder 34b in the axial direction 2. The second shaft shoulder 34b defines an axial surface which is designed for contact of the rotor disk 32 (or of the spacer element 50 mentioned further below in the case of positioning at the axial position 50c). In refinements, the rotor disk fixing 36 can fasten the rotor disk 32, for example, to the second shaft shoulder 34b. The rotor disk fixing 36 can be of non-positive and/or positively locking configuration. For example, the rotor disk fixing 36 can comprise a combination of a screw connection of the rotor disk 32 to the shaft and optionally a positively locking engagement of the rotor shaft 32 with the shaft, in particular with a shaft step which forms the second shaft shoulder 34b. In some refinements, the rotor disk 32 can comprise a fastening portion 38, via which the rotor disk 32 is connected to the shaft 34. The fastening portion 38 can be configured from a material (for example, a metallic material such as aluminum or ceramic material) with a higher strength than the holding body 37 (for example, plastic material, in particular an electrically insulating material). In particular, the material of the holding body 37 can have a lower electrical and/or thermal conductivity than the material of the fastening portion 38. This has the advantage that the rotor disk 32 is given a strength-increasing property by the fastening portion 38 and secondly an eddy current loss-reducing property by the non-metallic holding body 37. As an alternative to this, the holding body 37 and the fastening portion 38 can be produced from one part and/or material in a few refinements. In some refinements, the rotor disk 32, in particular its fastening portion 38, can be produced in one piece with the shaft 34. In refinements of this type, the rotor arrangement 30 cannot have the second shaft shoulder 34b, and the holding body 37 can be configured, in particular, separately from a different material (for example, plastic material).

As can be gathered, in particular, from FIGS. 2, 3 and 4, the axial flux machine 1 comprises, furthermore, a spacer element 50 which is designed and arranged between the rotor disk 32 and the axial bearing surface 12a so as to set the axial gaps 122a, 122b between the rotor disk 32 and the stators 20. As can be clearly gathered from the figures, it goes without saying that the spacer element 50 cannot be clamped indirectly between the rotor disk 32 and the axial bearing surface 12a, since the rotor disk 32 is arranged axially centrally and the axial bearing surface 12a is arranged to the side of the locating bearing 42 toward the first axial side 30a. Rather, the circumspect reader gathers that the spacer element 50 is arranged in an axial region between the rotor disk 32 and the axial bearing surface 12a. As a result, the arrangement of the spacer element 50 can also be expressed as being situated in an axial dimensional chain between the rotor disk 32 and the axial bearing surface 12a. The “axial dimensional chain between the rotor disk 32 and the axial bearing surface 12a” therefore contains the axially extending components/dimensions from the first axial side 30a of the locating bearing 42 as far as the rotor disk 32. In FIG. 4, they are, for example, the locating bearing 42 and the shaft 34 or a portion thereof. More precisely, the dimensional chain comprises an axial width 142 of the locating bearing 42 between the outer bearing shoulder 42a and the inner bearing shoulder 42b, and an axial width 132a (first shoulder-disk spacing 132a) of the shaft 34 between the first shaft shoulder 34a (against which the locating bearing 42 bears) and the first axial rotor surface 32a. As a result of the provision of the spacer element 50, the axially middle centering of the rotor disk 32 between the two stators 20 can be improved. In particular, deviations from axially central running on account of the tolerance chain of the parts (in particular, locating bearing 42 and shaft 34) between the axial bearing surface 12a (in the case of the locating bearing 42) and the rotor disk 32, but also tolerances of the two stators 20 or housing parts 12, 14 can be compensated for. Therefore, despite manufacturing tolerances of the parts which occur as a rule in the production method, a very small axial gap 122a, 122b (on both sides of the rotor disk 32) and at the same time highly homogeneous axial gaps 122a, 122b can be implemented. As a result of a small difference between the axial gaps 122a, 122b, the (resulting) axial forces which act on the rotor disk 32 can be reduced. In other words, the axial forces which act on the rotor disk 32 can be substantially equalized. In addition, the production can be simplified, since, as a result of the provision of the spacer element 50, the individual tolerances of the parts do not have to be so precise (or small) as without the spacer element 50.

With reference to FIGS. 2 and 4, furthermore, the spacer element 50 is arranged by way of example at a first axial position 50a (directly) between the axial bearing surface 12a and the locating bearing 42. In particular, the spacer element 50 bears at the first axial position 50a against the axial bearing surface 12a and against the opposite outer bearing shoulder 42a of the locating bearing 42.

In alternative refinements, the spacer element 50 can be arranged at a second axial position 50b (directly) between the locating bearing 42 and the first shaft shoulder 34a of the shaft 34 (see FIG. 4). In particular, the spacer element 50 can bear at the second axial position 50b against the first shaft shoulder 34a and against the opposite inner bearing shoulder 42b of the locating bearing 42.

In further alternative refinements, the spacer element 50 can be arranged at a third axial position 50c (directly) between the second shaft shoulder 34b of the shaft 34 and the rotor disk 32 (see FIG. 4). In particular, the spacer element 50 can bear at the third axial position 50c against the second shaft shoulder 34b and against the rotor disk 32, in particular the first axial rotor surface 32a. The present invention provides by way of example three different positioning possibilities 50a, 50b, 50c of the spacer element 50 within the tolerance chain of the parts of the rotor arrangement 30 between the axial bearing surface 12a (in the case of the locating bearing) and the rotor disk 32. Therefore, positioning of the spacer element 50 can be adapted to different embodiments of the axial flux machine 1 and/or to their production processes. For example, in particular, the first and the second axial position 50a, 50b are practicable in the case of rotor arrangements 30, in which the rotor disk 32 protrudes at least partially radially out of the shaft 34 (for example, is produced at least partially in one piece with the shaft 34).

FIGS. 3a and 3b show one exemplary embodiment of the spacer element 50. As shown, the spacer element 50 can be of annular configuration. The spacer element 50 can have an axial thickness 150 between two opposite axial surfaces. A homogeneous setting of the axial gaps 122a, 122b over their entire circumference can be achieved, in particular, by the annular embodiment. The annular spacer element 50 has an internal diameter 52, an external diameter 54 and a radial thickness 53 between the internal diameter 52 and the external diameter 54. The internal diameter 52, the external diameter 54 and the radial thickness 53 can be adapted to the respective axial position 50a, 50b, 50c. In embodiments, the internal diameter 52 can be between 40 mm and 70 mm, in particular between 45 mm and 65 mm. In embodiments, the external diameter 54 can be between 50 mm and 90 mm, in particular between 60 mm and 80 mm. In embodiments, the radial thickness 53 can be between 5 mm and 20 mm, in particular between 7.5 mm and 15 mm. The thickness 150 of the spacer element 50 can be 0.05 mm or more, 0.1 mm or more, in particular 0.2 mm or more, preferably 0.4 mm or 0.5 mm or more. In embodiments, the axial thickness 150 of the spacer element 50 can be from 0.05 mm to 2 mm, in particular from 0.05 mm to 1.5 mm. For example, the axial thickness 150 of the spacer element can have a value in 0.05 mm steps between 0.05 mm and 2.0 mm. The axial thickness 150 can be 0.1 mm, 0.15 mm, 0.2 mm or 0.25 mm, mentioning only some examples.

In embodiments of the axial flux machine 1, the axial thickness 150 can be configured in such a way that a difference between the axial gaps 122a, 122b is smaller than without the spacer element 50.

In embodiments of the axial flux machine, the axial thickness 150 can be configured in such a way that an (axial) difference between the first axial gap 122a and the second axial gap 122b is less than or equal to 0.5 mm. In particular, the axial thickness 150 can be configured in such a way that the difference between the first axial gap 122a and the second axial gap 122b is less than or equal to 0.2 mm. In some preferred embodiments, the axial thickness 150 can be configured in such a way that the difference between the first axial gap 122a and the second axial gap 122b is less than or equal to 0.1 mm. An improvement of the axially middle centering can be achieved by embodiments of this type. A great reduction of the resulting axial forces which act on the rotor disk 32 can be achieved, in particular, in comparison with greater differences between the axial gaps 122a, 122b.

In embodiments, the front axial gap 122a can be of smaller configuration than the rear axial gap 122b. In other words, the axial thickness 150 of the spacer element 50 can be configured in such a way that the front axial gap 122a is smaller than the rear axial gap 122b. Thermally induced vibrations or alternating stress can be avoided during operation or the risk thereof can at least be reduced by the smaller configuration of the first axial gap 122a. This risk can occur on account of thermal expansions of different magnitude at the first axial gap 122a and at the second axial gap 122b. On account of the arrangement of the locating bearing 42 on the same (first) axial side 30a as the first axial gap 122a, the first axial gap 122a tends to become smaller in the case of heating of the axial flux machine 1, in comparison with the second axial gap 122b.

In embodiments of the axial flux machine 1, the front axial gap 122a can be set to 1.5 mm±0.5 mm by the spacer element 50. In particular, the front axial gap 122a can be set to 1.5 mm±0.3 mm by the spacer element 50. In some preferred embodiments, the front axial gap 122a can be set to 1.5 mm±0.2 mm by the spacer element 50. In embodiments, the rear axial gap 122b can be set to 1.5 mm±0.5 mm by the spacer element 50. In particular, the rear axial gap 122b can be set to 1.5 mm±0.3 mm by the spacer element 50. In some preferred embodiments, the rear axial gap 122b can be set to 1.5 mm±0.2 mm by the spacer element 50.

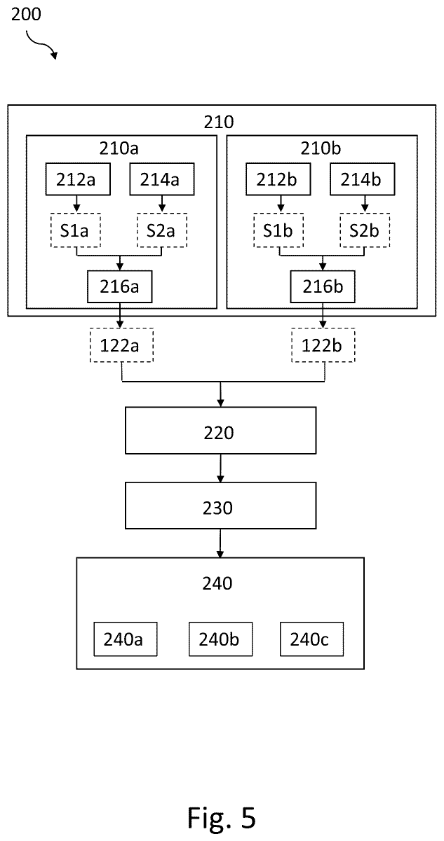

Furthermore, the present invention relates to a method 200 for setting axial gaps 122a, 122b between the rotor disk 32 and the stators 20 of an axial flux machine 1. The axial flux machine 1 comprises a housing 10 with an axial bearing surface 12a on a first axial side 30a, and a rotor arrangement 50 with a shaft 34 and the rotor disk 32 arranged on it. The rotor arrangement 30 is mounted on the first axial side 30a via a locating bearing 42 of a bearing arrangement 40 of the axial flux machine 1 against the axial bearing surface 12a. This can be, in particular, the above-described axial flux machine 1. The method 200 in accordance with the present disclosure will be described in the following text with reference to FIGS. 5, 6a, 6b and 7. Features of the axial flux machine 1 can fundamentally be applied to the method 200 or combined with the latter, and vice versa.

The diagrammatic flow chart of FIG. 5 shows exemplary steps of the method 200 for setting the axial gaps 122a, 122b of the axial flux machine 1. The steps and/or part steps of the method 200 can be carried out in the sequence shown. In embodiments, the steps and/or part steps shown can also, however, be carried out in a different sequence and/or at least partially in parallel.

As is shown in FIG. 5, the axial gaps 122a, 122b between the stators 20a, 20b and the rotor disk 32 are first of all determined 210. Subsequently, the difference between the axial gaps 122a, 122b is determined 220. Based on the determined difference, an axial thickness 150 of a spacer element 50 is defined 230. Defining 230 is carried out in such a way that the difference between the axial gaps 122a, 122b is reduced. Subsequently, a spacer element 50 with the defined thickness 150 is arranged 240 in an axial dimensional chain between the rotor disk 32 and the axial bearing surface 12a. Determining 210 of the axial gaps 122a, 122b is carried out, in particular, before the final assembly of the axial flux machine 1.

In this regard, FIGS. 6a and 6b show an axial flux machine 1 with (FIG. 6a) and without (FIG. 6b) a spacer element 50. FIG. 6a shows the front axial gap 122a on a substantially larger scale than the rear axial gap 122b for illustrative purposes. Here, the arrow directed to the right in the region of the permanent magnet 33 illustrates that the rotor disk 32 would have to be positioned further to the right with respect to the rear stator 20b relative to the stators 20, in order to run axially centrally. To this end, in accordance with the method 200, a difference of the axial gaps 122a, 122b is determined, and an axial thickness 150 of the spacer element 50 is defined. As is shown in FIG. 6b, the spacer element 50 with the defined axial thickness 150 is arranged by way of example at the first position 50a, with the result that the difference between the axial gaps 122a, 122b is reduced. As a result, the rotor disk 32 is arranged axially centrally.

In embodiments of the method 200, determining 210 the axial gaps 122a, 122b can generally comprise determining 212a, 212b axial rotor distances S1a, S1b, determining 214a, 214b axial stator distances S2a, S2b, and defining 216a, 216b differences between the respective axial stator distance S2a, S2b and the respective axial rotor distance S1a, S1b (see FIGS. 5 and 7). The axial rotor distances S1a, S1b are distances between an outer bearing shoulder 42a on the first axial side 30a of the locating bearing 42 and a respective axial surface 32a, 32b of the rotor disk 32. The axial stator distances S2a, S2b are distances between the axial bearing surface 12a and a respective axial stator surface 22a, 22b on the stators 20, 20a, 20b.

In embodiments of the method 200, determining 212a, 212b the respective axial rotor distance S1a, S1b can comprise a plurality of, in particular at least three, measurements at positions distributed in the circumferential direction 6 of the respective axial rotor surface 32a, 32b, and averaging the respective plurality of measurements. In embodiments of the method, determining 214a, 214b the respective axial stator distance S2a, S2b can comprise a plurality of, in particular at least three, measurements at positions distributed in the circumferential direction 6 of the respective axial stator surface 22a, 22b, and averaging the respective plurality of measurements. Within the context of this disclosure, the axial gaps 122a, 122b (and their difference) refer to mean dimensions which are measured at room temperature and not during operation of the axial flux machine 1. Mean dimensions are to be understood to be mean values of values measured at at least three different positions in the circumferential direction 6, in particular at at least three positions distributed homogeneously in the circumferential direction 6 (for example, offset in each case by 120° in the circumferential direction 6). In embodiments, mean values can be formed over at least three different positions in the circumferential direction 6 on a plurality of reference circles with different radii (in particular (maximum) radially outer reference circle and (maximum) radially inner reference circle). For example, six measurements (in each case three circumferentially distributed measurements on two different reference circles) can be performed on the first stator 20a or its axial surface 22a.

In detail and, furthermore, in relation to FIGS. 5 and 7, the axial gaps 122a, 122b (and their difference) can also be determined 210 individually. Accordingly, determining 210 the axial gaps 122a, 122b can comprise determining 210a a first axial gap 122a between a first stator 20a and a first axial rotor surface 32a of the rotor disk 32. In addition, determining 210 the axial gaps 122a, 122b can comprise determining 220a a second axial gap 122b between a second stator 20b and a second axial rotor surface 32b of the rotor disk 32. As has already been mentioned, the axial gaps 122a, 122b can be determined before the final assembly of the axial flux machine 1. For example, the axial gaps 122a, 122b can be determined 210 by measurements on part assemblies, as shown in FIG. 7. A first part assembly can comprise the rotor arrangement 30 and the locating bearing 42. A second part assembly can comprise the first housing part 12 with the first stator 20a. A third part assembly can comprise the second housing part 14 with the second stator 20b. FIG. 7 shows the diagrammatic measuring of the axial gaps 122a, 122b or the rotor distances S1a, S1b and the stator distances S2a, S2b at the part assemblies.

Determining 210a the first axial gap 122a can comprise determining 212a a first axial rotor distance S1a between an outer bearing shoulder 42a on the first axial side 30a of the locating bearing 42 and a first axial surface 32a of the rotor disk 32. As is shown in FIG. 7, for example, individual axial widths can be determined on the first part assembly and added. For example, an axial width 142 of the locating bearing 42 and a first shoulder-disk spacing 132a can be determined. Here, the first shoulder-disk spacing 132a denotes an axial width 132a between the first shaft shoulder 34a, against which the locating bearing 42 bears toward the second axial side 30b, and the first axial rotor surface 32a (or the second shaft shoulder 34b; see FIG. 4). The first rotor distance S1a from the first axial rotor surface 32a results from the sum of the axial width 142 and the first shoulder-disk spacing 132a. In embodiments, the first axial rotor distance SIa can also be measured directly between the outer bearing shoulder 42a and the first axial surface 32a (or the second shaft shoulder 34b if the second shaft shoulder 34b is flush with the first axial surface 32 in the assembled state). In embodiments, determining 212a the first axial rotor distance S1a can comprise a plurality of, in particular at least three, measurements at positions distributed in the circumferential direction 6 of the first axial rotor surface 32a, and averaging the plurality of measurements. In particular, the positions can be distributed in the circumferential direction and/or in the radial direction.

In addition, determining 210a the first axial gap 122a can comprise determining 214a a first axial stator distance S2a between the axial bearing surface 12a and a first axial stator surface 22a on the first stator 20a. In the exemplary embodiment which is shown in FIG. 7, the first stator distance S2a can be measured directly on the second part assembly, since the first stator 20a is arranged in the same (first) housing part 12 as the axial bearing surface 12a. In embodiments, determining 214a the first axial stator distance S2a can comprise a plurality of, in particular at least three, measurements at positions distributed in the circumferential direction 6 of the first axial stator surface 22a, and averaging the plurality of measurements. In particular, the positions can be distributed in the circumferential direction and/or in the radial direction.

Subsequently, the first axial gap 122a can be determined 210a by defining 216a a difference between the first axial stator distance S2a and the first axial rotor distance S1a.

Determining 210b the second axial gap 122a can comprise determining 212b a second axial rotor distance S1b between the outer bearing shoulder 42a and the second axial surface 32b of the rotor disk 32. As is shown in FIG. 7, for example, individual axial widths can be determined on the first part assembly and added. For example, an axial width 142 of the locating bearing 42 and a second shoulder-disk spacing 132b can be determined. Here, the second shoulder-disk spacing 132b denotes an axial width 132b between the first shaft shoulder 34a, against which the locating bearing 42 bears toward the second axial side 30b, and the second axial rotor surface 32b. The second rotor distance S1b from the second axial rotor surface 32b results from the sum of the axial width 142 and the second shoulder-disk spacing 132b. In embodiments, the second axial rotor distance S1b can also be measured directly between the outer bearing shoulder 42a and the second axial surface 32b. In embodiments, determining 212b the second axial rotor distance S1b can comprise a plurality of, in particular at least three, measurements at positions distributed in the circumferential direction 6 of the second axial rotor surface 32b, and averaging the plurality of measurements. In particular, the positions can be distributed in the circumferential direction and/or in the radial direction.

In addition, determining 210b the second axial gap 122a can comprise determining 214b a second axial stator distance S2b between the axial bearing surface 12a and a second axial stator surface 22b on the second stator 20b. As is shown in FIG. 7, for example, individual axial widths can be determined on the first and second part assembly and added. For example, a first axial housing distance 120a and a second axial housing distance 120b can be determined. Here, the first axial housing distance 120a denotes an axial distance between the axial bearing surface 12a and a first housing contact surface 12b of the first housing part 12. The first housing contact surface 12b is a contact surface 12b of the first housing part 12, at which an axial contact with the second housing part 14 is established. The second axial housing distance 120b denotes an axial distance between the second axial stator surface 22b and a second housing contact surface 14b of the second housing part 14. The second housing contact surface 14b is a contact surface 14b of the second housing 14, at which an axial contact with the first housing part 12 (or its contact surface 12a) is established in the assembled state. In embodiments, determining 214b the second axial stator distance S2b can comprise a plurality of, in particular at least three, measurements at positions distributed in the circumferential direction 6 of the second axial stator surface 22b, and averaging the plurality of measurements. In particular, the positions can be distributed in the circumferential direction and/or in the radial direction.

Subsequently, the second axial gap 122b can be determined 210b by defining 216b a difference between the second axial stator distance S2b and the second axial rotor distance S1b.

After determining 210 the axial gaps 122a, 122b, the axial thickness 150 of the spacer element is defined 230 (see FIG. 5). Here, the axial thickness 150 of the spacer element 50 can be defined 230 in such a way that a first axial gap 122a of the two axial gaps 122a, 122b which is formed on the first axial side 30a′ is smaller than a second axial gap 122b. In other words, the axial thickness 150 of the spacer element 50 is configured in such a way that the front axial gap 122a is smaller than the rear axial gap 122b. Thermally induced vibrations or alternating stress can be avoided during operation or the risk thereof can at least be reduced by the smaller configuration of the first axial gap 122a. This risk can exist on account of thermal expansions of different magnitude at the first axial gap 122a and at the second axial gap 122b. On account of the arrangement of the locating bearing 42 on the same (first) axial side 30a as the first axial gap 122a, the first axial gap 122a tends to become smaller in the case of heating of the axial flux machine 1, in comparison with the second axial gap 122b.

In embodiments of the method 200, the axial thickness 150 of the spacer element 50 can be defined 230 in such a way that the difference between the axial gaps 122a, 122b is less than or equal to 0.5 mm. In particular, the axial thickness 150 of the spacer element 50 can be defined 230 in such a way that the difference between the axial gaps 122a, 122b is less than or equal to 0.2 mm, preferably less than or equal to 0.1 mm. An improvement of the axially middle centering of the rotor disk 32 can be achieved by embodiments of this type. A pronounced reduction of the resulting axial forces which act on the rotor disk 32 can be achieved, in particular, in comparison with greater differences between the axial gaps 122a, 122b.

In embodiments of the method 200, the axial thickness 150 of the spacer element 50 can be defined 230 in such a way that the first axial gap 122a and/or the second axial gap 122b is, as a result of the spacer element 50, 1.5 mm±0.5 mm, in other words from 1 mm to 2 mm. In particular, the axial thickness 150 of the spacer element 50 can be defined 230 in such a way that the first axial gap 122a and/or the second axial gap 122b are/is set by the spacer element 50 to 1.5 mm±0.3 mm, preferably 1.5 mm±0.2 mm.

In embodiments of the method 200, the axial flux machine 1 can be provided with nominal dimensions, which influence the axial gaps 122a, 122b, such that a spacer element 50 with an axial nominal thickness of at least 0.5 mm is required to reduce a nominal difference between the axial gaps 122a, 122b. In embodiments, the axial thickness 150 of the spacer element 50 can be defined 230 by virtue of the fact that the axial thickness 150 is increased or reduced starting from the axial nominal thickness. In embodiments, the increase or reduction can take place based on the determined difference between the axial gaps 122a, 122b.

In embodiments of the method 200, arranging 240 the spacer element 50 can comprise one of the following arrangements. Arranging 240a the spacer element 50 at a first axial position 50a between the axial bearing surface 12a and the locating bearing 42. As an alternative, arranging 240b the spacer element 50 at a second axial position 50b between the locating bearing 42 and a first shaft shoulder 34a. As an alternative, furthermore, arranging 240c the spacer element 50 at a third axial position 50c between a second shaft shoulder 34b and the rotor disk 32.

Although the present invention has been described above and is defined in the appended claims, it should be understood that, as an alternative, the invention can also be defined in accordance with the following embodiments.

1. An axial flux machine (1) comprising:
a housing (10),
two stators (20),
a rotor arrangement (30) with a shaft (34) and a rotor disk (32) arranged on it, and
a bearing arrangement (40) which mounts the rotor arrangement (30) rotatably in the housing (10),
wherein the rotor arrangement (30) is mounted on a first axial side (30a) via a locating bearing (42) of the bearing arrangement (40) against an axial bearing surface (12a) of the housing (10), distinguished by a spacer element (50) which is designed and arranged between the rotor disk (32) and the axial bearing surface (12a) so as to set axial gaps (122a, 122b) between the rotor disk (32) and the stators (20).

2. The axial flux machine (1) in accordance with embodiment 1, wherein the spacer element (50) is arranged at a first axial position (50a) between the axial bearing surface (12a) and the locating bearing (42), at a second axial position (50b) between the locating bearing (42) and the first shaft shoulder (34a), or at a third axial position (50c) between a second shaft shoulder (34b) and the rotor disk (32).

3. The axial flux machine (1) in accordance with embodiment 2, wherein the spacer element (50) is arranged at the first axial position (50a), and wherein the spacer element (50) bears against the axial bearing surface (12a) and against an opposite outer bearing shoulder (42a) of the locating bearing (42).

4. The axial flux machine (1) in accordance with embodiment 2, wherein the spacer element (50) is arranged at the second axial position (50b), and wherein the spacer element (50) bears against the first shaft shoulder (34a) and against an opposite inner bearing shoulder (42b) of the locating bearing (42).

5. The axial flux machine (1) in accordance with embodiment 2, wherein the spacer element (50) is arranged at the third axial position (50c), and wherein the spacer element (50) bears against the second shaft shoulder (34b) and against the rotor disk (32).

6. The axial flux machine (1) in accordance with one of the preceding embodiments, wherein the spacer element (50) is of annular configuration and has an axial thickness (150) between two opposite axial surfaces, and optionally wherein the axial thickness (150) is from 0.05 mm to 2 mm.

7. The axial flux machine (1) in accordance with embodiment 6, wherein the axial thickness (150) is configured in such a way that a difference between the axial gaps (122a, 122b) is smaller than without the spacer element (50).

8. The axial flux machine (1) in accordance with either of embodiments 6 or 7, wherein the axial thickness (150) is configured in such a way that a difference of the axial gaps (122a, 122b) between the rotor disk (32) and the stators (20) is less than 0.5 mm, in particular less than or equal to 0.2 mm, preferably less than or equal to 0.1 mm.

9. The axial flux machine (1) in accordance with one of embodiments 6 to 8, wherein the axial gaps (122a, 122b) comprise a front axial gap (122a) on the first axial side (30a) and a rear axial gap (122b) on a second side (30b) lying opposite the first side (30a), wherein the front axial gap (122a) is of smaller configuration than the rear axial gap (122b).

10. The axial flux machine (1) in accordance with one of embodiments 6 to 9, wherein a front axial gap (122a) and/or a rear axial gap (122b) are/is set by the spacer element (50) to 1.5 mm±0.5 mm, in particular 1.5 mm±0.3 mm, preferably 1.5 mm±0.2 mm.

11. The axial flux machine (1) in accordance with one of the preceding embodiments, wherein the rotor disk (32) comprises a holding body (37) and a plurality of permanent magnets (33) which are distributed in the circumferential direction (6) and are fastened to the holding body (37).

12. The axial flux machine (1) in accordance with embodiment 11, wherein the plurality of permanent magnets (33) define a first axial rotor surface (32a) and an opposite second axial rotor surface (32b) of the rotor disk (32).

13. The axial flux machine (1) in accordance with one of the preceding embodiments, wherein the rotor disk (32) is connected fixedly to the shaft (34) for conjoint rotation via a rotor disk fixing (36).

14. The axial flux machine (1) in accordance with one of the preceding embodiments, wherein, furthermore, the bearing arrangement (40) comprises a bearing fixing (46) which braces the locating bearing (42) in the axial direction (2) toward the axial bearing surface (12a).

15. The axial flux machine (1) in accordance with one of the preceding embodiments, wherein the housing (10) comprises a first housing part (12) and a second housing part (14), wherein a first stator (20a) of the two stators (20) is fastened in the first housing part (12), and a second stator (20b) of the two stators (20) is fastened in the second housing part (14).

16. A high voltage fan (100) comprising a fan impeller (101) and an axial flux machine (1) in accordance with one of the preceding embodiments, wherein the fan impeller is coupled fixedly to the shaft (34) for conjoint rotation outside the housing (10).

17. A method (200) for setting axial gaps (122a, 122b) between the rotor disk (32) and the stators (20) of an axial flux machine (1), the axial flux machine (1) comprising a housing (10) with an axial bearing surface (12a) on a first axial side (30a), a rotor arrangement (30) with a shaft (34) and the rotor disk (32) arranged on it, wherein the rotor arrangement (30) is mounted on the first axial side (30a) via a locating bearing (42) of a bearing arrangement (40) of the axial flux machine (1) against the axial bearing surface (12a), wherein the method comprises:
determining (210) the axial gaps (122a, 122b) between the stators (20a, 20b) and the rotor disk (32),
determining (220) the difference between the axial gaps (122a, 122b),
defining (230), based on the determined difference, an axial thickness (150) of a spacer element (50), with the result that the difference is reduced,
arranging (240) the spacer element (50) in an axial dimensional chain between the rotor disk (32) and the axial bearing surface (12a).

18. The method (200) in accordance with embodiment 17, wherein determining (210) the axial gaps (122a, 122b) comprises
determining (212a, 212b) axial rotor distances (S1a, S1b) between an outer bearing shoulder (42a) on the first axial side (30a) of the locating bearing (42) and a respective axial surface (32a, 32b) of the rotor disk (32).

19. The method (200) in accordance with embodiment 18, wherein determining (212a, 212b) the respective axial rotor distance (S1a, S1b) comprises a plurality of, in particular at least three, measurements at positions distributed in the circumferential direction (6) of the respective axial rotor surface (32a, 32b), and averaging the respective plurality of measurements.

20. The method (200) in accordance with one of the embodiments 17 to 19, wherein determining (210) the axial gaps (122a, 122b) comprises
determining (214a, 214b) axial stator distances (S2a, S2b) between the axial bearing surface (12a) and a respective axial stator surface (22a, 22b) on the stators (20, 20a, 20b).

21. The method (200) in accordance with embodiment 20, wherein determining (214a, 214b) the respective axial stator distance (S2a, S2b) comprises a plurality of, in particular at least three, measurements at positions distributed in the circumferential direction (6) of the respective axial stator surface (22a, 22b), and averaging the respective plurality of measurements.

22. The method (200) in accordance with one of embodiments 17 to 21 if at least dependent on claims 18 and 20, wherein determining (210) the axial gaps (122a, 122b) comprises
defining (216a, 216b) differences between the respective axial stator distance (S2a, S2b) and the respective axial rotor distance (S1a, S1b).

23. The method (200) in accordance with embodiment 17, wherein determining (210) the axial gaps (122a, 122b) comprises
determining (210a) a first axial gap (122a) between a first stator (20a) and a first axial rotor surface (32a) of the rotor disk (32), and
determining (220a) a second axial gap (122b) between a second stator (20b) and a second axial rotor surface (32b) of the rotor disk (32).

24. The method (200) in accordance with embodiment 23, wherein determining (210a) the first axial gap (122a) comprises
determining (212a) a first axial rotor distance (S1a) between an outer bearing shoulder (42a) on the first axial side (30a) of the locating bearing (42) and a first axial surface (32a) of the rotor disk (32).

25. The method (200) in accordance with embodiment 24, wherein determining (212a) the first axial rotor distance (S1a) comprises a plurality of, in particular at least three, measurements at positions distributed in the circumferential direction (6) of the first axial rotor surface (32a), and averaging the plurality of measurements.

26. The method (200) in accordance with one of embodiments 23 to 25, wherein determining (210a) the first axial gap (122a) comprises
determining (214a) a first axial stator distance (S2a) between the axial bearing surface (12a) and a first axial stator surface (22a) on the first stator (20a).

27. The method (200) in accordance with embodiment 26, wherein determining (214a) the first axial stator distance (S2a) comprises a plurality of, in particular at least three, measurements at positions distributed in the circumferential direction (6) of the first axial stator surface (22a), and averaging the plurality of measurements.

28. The method (200) in accordance with one of embodiments 23 to 27 if at least dependent on claims 24 and 26, wherein determining (210a) the first axial gap (122a) comprises defining (216a) a difference between the first axial stator distance (S2a) and the first axial rotor distance (S1a).

29. The method (200) in accordance with one of embodiments 23 to 28, wherein determining (210b) the second axial gap (122b) comprises determining (212b) a second axial rotor distance (S1b) between the outer bearing shoulder (42a) and the second axial surface (32b) of the rotor disk (32).

30. The method (200) in accordance with embodiment 29, wherein determining (212b) the second axial rotor distance (S1b) comprises a plurality of, in particular at least three, measurements at positions distributed in the circumferential direction (6) of the second axial rotor surface (32b), and averaging the plurality of measurements.

31. The method (200) in accordance with one of embodiments 23 to 30, wherein determining (210b) the second axial gap (122b) comprises determining (214b) a second axial stator distance (S2b) between the axial bearing surface (12a) and a second axial stator surface (22b) on the second stator (20b).

32. The method (200) in accordance with embodiment 31, wherein determining (214b) the second axial stator distance (S2b) comprises a plurality of, in particular at least three, measurements at positions distributed in the circumferential direction (6) of the second axial stator surface (22b), and averaging the plurality of measurements.

33. The method (200) in accordance with one of embodiments 23 to 32 if at least dependent on claims 29 and 31, wherein determining (210b) the second axial gap (122b) comprises
defining (216b) a difference between the second axial stator distance (S2b) and the second axial rotor distance (S1b).

34. The method (200) in accordance with one of embodiments 17 to 33, wherein the axial thickness (150) of the spacer element (50) is defined (230) in such a way that a first axial gap (122a) of the two axial gaps (122a, 122b) which is formed on the first axial side (30a) is smaller than a second axial gap (122b).

35. The method (200) in accordance with one of embodiments 17 to 34, wherein the axial thickness (150) of the spacer element (50) is defined (230) in such a way that the difference between the axial gaps (122a, 122b) is less than or equal to 0.5 mm, in particular less than or equal to 0.2 mm, preferably less than or equal to 0.1 mm.

36. The method (200) in accordance with one of embodiments 17 to 35, wherein the axial thickness (150) of the spacer element (50) is defined (230) in such a way that a first axial gap (122a) and/or a second axial gap (122b) are/is set by the spacer element (50) to 1.5 mm±0.5 mm, in particular 1.5 mm±0.3 mm, preferably 1.5 mm±0.2 mm.

37. The method (200) in accordance with one of embodiments 17 to 36, wherein the axial flux machine (1) is provided with dimensional sizes which influence the axial gaps (122a, 122b), in such a way that a spacer element (50) with an axial nominal thickness of at least 0.5 mm is required in order to reduce a nominal difference between the axial gaps (122a, 122b).

38. The method (200) in accordance with embodiment 37, wherein the axial thickness (150) of the spacer element (50) is defined (230) by virtue of the fact that the axial thickness (150) is increased or reduced starting from the axial nominal thickness.

39. The method (200) in accordance with embodiment 38, wherein the increase or reduction takes place based on the determined difference between the axial gaps (122a, 122b).

40. The method (200) in accordance with one of embodiments 17 to 39, wherein arranging (240) the spacer element (50) comprises one of the following:
arranging (240a) the spacer element (50) at a first axial position (50a) between the axial bearing surface (12a) and the locating bearing (42),
arranging (240b) the spacer element (50) at a second axial position (50b) between the locating bearing (42) and a first shaft shoulder (34a), or
arranging (240c) the spacer element (50) at a third axial position (50c) between a second shaft shoulder (34b) and the rotor disk (32).

Reference signs

| | | | |
|---|---|---|---|
| 1 | Axial flux machine | 44 | Floating bearing |
| 2 | Axial direction | 46 | Bearing fixing |
| 4 | Radial direction | 50 | Spacer element |
| 6 | Circumferential direction | 52 | Internal diameter |
| 10 | Housing | 53 | Radial thickness |
| 12 | First housing part | 54 | External diameter |
| 12a | Axial bearing surface | 50a | First axial position |
| 12b | First housing contact surface | 50b | Second axial position |
| 14 | Second housing part | 50c | Third axial position |
| 14b | Second housing contact surface | 100 | High voltage fan |
| 20 | Stator | 101 | Fan impeller |
| 20a | First stator | 120a | First axial housing distance |
| 22a | First axial stator surface | 120b | Second axial housing distance |
| 20b | Second stator | 122a | First axial gap |
| 22b | Second axial stator surface | 122b | Second axial gap |
| 30 | Rotor arrangement | 132a | First shoulder-disk spacing |
| 30a | First axial side | 132b | Second shoulder-disk spacing |
| 30b | Second axial side | 142 | Axial width, locating bearing |
| 32 | Rotor disk | 150 | Axial thickness |
| 32a | First axial rotor surface | 200 | Method |
| 32b | Second axial rotor surface | 210, 210a/b | Determining axial gaps |
| 33 | Permanent magnet | 212a/b | Determining axial rotor distances |
| 34 | Shaft | 214a/b | Determining axial stator distances |
| 34a | First shaft shoulder | 216a/b | Defining axial differences |
| 34b | Second shaft shoulder | 220 | Determining the difference |
| | | | between the axial gaps |
| 36 | Rotor disk fixing | 230 | Determining axial thickness |
| 37 | Holding body | 240, 240a/b/c | Arranging spacer element |
| 38 | Fastening portion | S1a | First axial rotor distance |
| 40 | Bearing arrangement | S1b | Second axial rotor distance |
| 42 | Locating bearing | S2a, 112 | First axial stator distance |
| 42a | Outer bearing shoulder | S2b | Second axial stator distance |
| 42b | Inner bearing shoulder | | |

What is claimed is:

1. An axial flux machine comprising:
a housing,
two stators,
a rotor arrangement with a shaft and a rotor disk arranged on the shaft, and
a bearing arrangement which mounts the rotor arrangement rotatably in the housing,
wherein the rotor arrangement is mounted on a first axial side via a locating bearing of the bearing arrangement against an axial bearing surface of the housing, and
wherein a spacer element is arranged between the rotor disk and the axial bearing surface so as to set axial gaps between the rotor disk and the stators.

2. The axial flux machine as claimed in claim 1, wherein the spacer element is arranged at a first axial position between the axial bearing surface and the locating bearing, at a second axial position between the locating bearing and a first shaft shoulder, or at a third axial position between a second shaft shoulder and the rotor disk.

3. The axial flux machine as claimed in claim 2, wherein the spacer element is of annular configuration and has an axial thickness between two axial surfaces which lie opposite one another, wherein the axial thickness is configured in such a way that a difference between the axial gaps is smaller than without the spacer element, and wherein the axial thickness is from 0.05 mm to 2 mm.

4. The axial flux machine as claimed in claim 1, wherein the spacer element is of annular configuration and has an axial thickness between two axial surfaces which lie opposite one another, wherein the axial thickness is configured in such a way that a difference between the axial gaps is smaller than without the spacer element, and wherein the axial thickness is from 0.05 mm to 2 mm.

5. The axial flux machine as claimed in claim 4, wherein the axial thickness is configured in such a way that a difference of the axial gaps between the rotor disk and the stators is less than or equal to 0.5 mm.

6. The axial flux machine as claimed in claim 4, wherein the axial gaps comprise a front axial gap on the first axial side and a rear axial gap on a second side which lies opposite the first side, wherein the front axial gap is of smaller configuration than the rear axial gap.

7. The axial flux machine as claimed in claim 6, wherein the front axial gap or the rear axial gap is set by the spacer element to 1.5 mm±0.5 mm.

8. A high voltage fan comprising a fan impeller and an axial flux machine as claimed in claim 1, wherein the fan impeller is coupled fixedly to the shaft for conjoint rotation outside the housing.

9. A method for setting axial gaps between the rotor disk and the stators of an axial flux machine, the axial flux machine comprising a housing with an axial bearing surface on a first axial side, a rotor arrangement with a shaft and the rotor disk arranged on the shaft, wherein the rotor arrangement is mounted on the first axial side via a locating bearing of a bearing arrangement of the axial flux machine against the axial bearing surface,
wherein the method comprises:
determining the axial gaps between the stators and the rotor disk,
determining the difference between the axial gaps,
defining, based on the determined difference, an axial thickness of a spacer element, with the result that the difference is reduced, and
arranging the spacer element in an axial dimensional chain between the rotor disk and the axial bearing surface.

10. The method as claimed in claim 9, wherein determining the axial gaps comprises
determining axial rotor distances between an outer bearing shoulder on the first axial side of the locating bearing and a respective axial surface of the rotor disk.

11. The method as claimed in claim 10, wherein determining the respective axial rotor distance comprises at least three measurements at positions distributed in the circumferential direction of the respective axial rotor surface and averaging of the respective plurality of measurements.

12. The method as claimed in claim 9, wherein determining the axial gaps comprises
determining axial stator distances between the axial bearing surface and a respective axial stator surface on the stators.

13. The method as claimed in claim 12, wherein determining the respective axial stator distance comprises at least three measurements at positions distributed in the circumferential direction of the respective axial stator surface and averaging of the respective plurality of measurements.

14. The method as claimed in claim 9, wherein determining the axial gaps comprises
defining differences between the respective axial stator distance and the respective axial rotor distance.

15. The method as claimed in claim 9, wherein the axial thickness of the spacer element is defined in such a way that a first axial gap of the two axial gaps which is formed on the first axial side is smaller than a second axial gap.

16. The method as claimed in claim 9, wherein the axial thickness of the spacer element is defined in such a way that the difference between the axial gaps is less than or equal to 0.5 mm.
